(19) United States
(12) Patent Application Publication
(10) Pub. No.: US 2021/0261334 A1
(43) Pub. Date: Aug. 26, 2021

(54) A System for Determining the Location of Mobile Units in a Warehouse and a Warehouse Provided with Such System

(71) Applicant: Hivetracker SA, Nyon (CH)

(72) Inventors: Pietro Ruggiero Ruggieri, Bogis Bossey (CH); Gianfranco Avitabile, Figline Valdarano (IT)

(73) Assignee: Hivetracker SA, Nyon (CH)

(21) Appl. No.: 17/251,180

(22) PCT Filed: Jun. 11, 2018
(86) PCT No.: PCT/EP2018/065276

§ 371 Date: Dec. 10, 2020

(51) Int. Cl. B65G 1/137

(52) U.S. Cl. CPC B65G 1/1375

(57) ABSTRACT

System (100) for determining the location of at least one mobile unit within a warehouse, said mobile unit being configured to receive radio frequency signals which frequencies are comprised between 5,725 GHz and 5,875 GHz and to transmit radio frequency signals which frequencies are comprised between 2.4 GHz and 2.5 GHz and between 433.05 MHz and 434.79 MHz.

### FIELD OF THE INVENTION

The invention relates to the field of stock management systems. The invention concerns, in particular, a system for determining the location of at least one mobile unit within a warehouse, said mobile unit being configured to receive radio frequency signals which frequencies are comprised between 5,725 GHz and 5,875 GHz and to transmit radio frequency signals which frequencies are comprised between 2.4 GHz and 2.5 GHz and between 433.05 MHz and 434.79 MHz.

### BACKGROUND OF THE INVENTION

Nowadays, systems for managing stocks in warehouses using wireless communication devices are well known. For instance, RFID technology is widely applied to, for instance, stock management systems or supply chain management systems. For some of these systems, a common problem that has to be addressed concerns the location of goods or units that are managed within such environments. Indeed, an efficient and useful stock management system must provide functionalities to allow constant tracking of the location of the mobile units it manages. Moreover, usually the location of mobile units arranged on items such as goods or forklifts must be provided with a rather decent level of accuracy. It indeed makes no sense to provide location determination functionalities if locations can only be approximately determined.

Consequently, to address this problem, some of these systems rely on GPS devices that provide location determination functionalities with a sufficiently high level of accuracy. However, GPS devices are expensive and, in accordance with the goods or units which location must be tracked, the use of GPS device sometimes represents a too heavy investment. However, even for these goods or units which nature disqualifies the use of GPS devices, the problem of location determination with a great level of accuracy remains a challenge that must be overcome.

### SUMMARY OF THE INVENTION

The invention is aiming to overcome these flaws by addressing the above presented challenge.

In this respect, the goal of the invention is to provide a system for tracking location of mobile units in a warehouse, which implementation costs are minimized with respect to GPS-based stock management systems, and which nevertheless allows to reach an accuracy level in terms location determination which is similar to GPS-based stock management systems. Accordingly, the goal of the invention is to provide a system for determining the location of mobile units, i.e. electronic tags, which, without using any GPS device, provides location m determination functionalities allowing location of mobile units within a warehouse to be determined with an error margin inferior to 50 cm.

This goal is achieved by a system for determining the location of at least one mobile unit within a warehouse, said mobile unit being configured to receive radio frequency signals which frequencies are comprised between 5,725 GHz and 5,875 GHz and to transmit radio frequency signals which frequencies are comprised m between 2.4 GHz and 2.5 GHz and between 433.05 MHz and 434.79 MHz, said system comprising:
at least a first device detection unit and a second device detection unit, both being configured to transmit radio frequency signals which frequencies are comprised between 5,725 GHz and 5,875 GHz and to receive radio frequency signals which frequencies are comprised between 2.4 GHz and 2.5 GHz, and
at least one identification detection unit configured to transmit radio frequency signals which frequencies are comprised between 5,725 GHz and 5,875 GHz and to receive radio frequency signals which frequencies are comprised 433.05 MHz and 434.79 MHz.

According to one aspect of the invention, both of said first device detection unit and said second device detection unit may comprise a look-up table in which at least one constant-amplitude zero auto-correlation sequence is stored.

According to another aspect of the invention, both of said first device detection unit and said second device detection unit may be configured to allow said sequence to be encoded using orthogonal frequency-division multiplexing to determine an encoded sequence sample.

m According to another aspect of the invention, said look-up table may include at least one version of said encoded sequence sample.

According to another aspect of the invention, both of said first device detection unit and said second device detection unit may comprise a digital signal processor.

According to another aspect of the invention, both of said first device detection unit and said second device detection unit may comprise a low-noise amplifier.

According to another aspect of the invention, both of said first device detection unit and said second device detection unit may comprise an analog-to-digital converter and a digital-to-analog converter.

According to another aspect of the invention, both of said first device detection unit and said second device detection unit may comprise at least one low-pass filter.

According to another aspect of the invention, both of said first device detection unit and said second device detection unit may comprise a digital clock.

According to another aspect of the invention, the system may further comprise a central management system comprising at least one processor, at least one computer-readable storage media and communication means for communicating via radio frequency signals with said m first device detection unit, said second device detection unit and/or said identification detection unit.

According to another aspect of the invention, said second device detection unit may comprise fixation means for fixing said second device detection unit in a rack.

According to another object, a warehouse according to the invention comprises a system as described above.

According to another aspect of the invention, said first device detection unit may be arranged on one side of said warehouse, said identification detection unit may be arranged on the other side of said warehouse and said second device detection unit may be arranged between said first device detection unit and said second device detection unit.

Other features and advantages of the invention will become apparent to the person skilled in the art from the description, the drawings and the claims.

### BRIEF DESCRIPTION OF THE FIGURES

FIG. 1 schematically illustrates some elements of the system according to the invention,

FIG. 2 schematically illustrates a rack arranged in a row of warehouse provided with a system according to the invention,

FIG. 3A schematically illustrates parts of the system according to the invention,

FIG. 3B schematically illustrates parts of the system according to the invention,

FIG. 4 schematically illustrates some elements of a device detection unit of a system according to the invention,

FIG. 5 shows radiofrequency signals received by a device detection unit of a system according to the invention, and

FIG. 6 schematically illustrates elements of a mobile unit which location is determined with a system according to the invention.

### DETAILED DESCRIPTION OF THE INVENTION

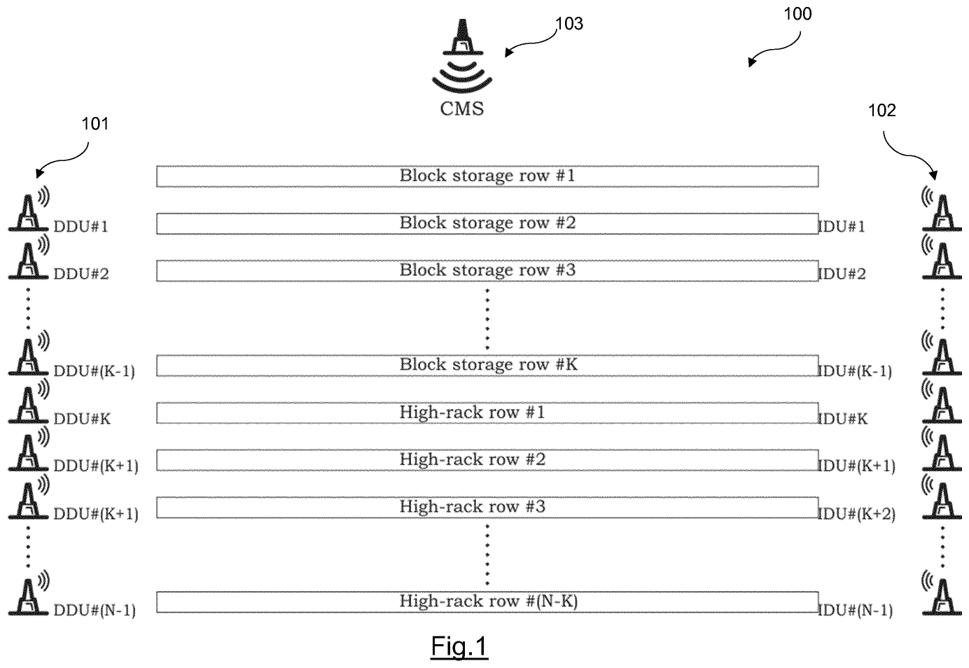

As illustrated on FIG. 1, the system 100 for determining location of mobile units within a warehouse comprises a plurality of device detection units 101 and a plurality of identification detection units 102. For sake of simplicity, in the forthcoming sections we assume that the warehouse is a 250 m by 100 m rectangle with a 25,000 m2 area. Preferably, a plurality of racks is arranged in each row where at least one good, at least one pallet or at least one piece of computer hardware may be arranged.

According to a preferred embodiment of the invention, for each row of the warehouse, a device detection unit (DDU) 101 is arranged on one side of the row (left side on FIG. 1) while an identification detection unit 102 (IDU) is arranged at the the opposite end of the row (right side on FIG. 1). As explained below, each DDU in the leftmost column is devoted to the distance determination of the mobile units roaming in the controlled row. On the other hand, each IDU in the rightmost column is devoted to the mobile units' identification in the same row.

The units operate in the free ISM frequencies, accessing both the 2.4 and the 5.8 GHz bands, using the low-power level consistent with ETSI/FCC rules. As such, each DDU is adapted and configured to transmit radio frequency signals radio frequency signals which frequencies are comprised between 5,725 GHz and 5,875 GHz and to receive radio frequency signals which frequencies are comprised between 2.4 GHz and 2.5 GHz. Similarly, each IDU is adapted and configured to transmit radio frequency signals which frequencies are comprised between 5,725 GHz and 5,875 GHz and to receive radio frequency signals which frequencies are comprised 433.05 MHz and 434.79 MHz.

The system 100 further comprises a central monitoring system (CMS) 103 which comprises at least one processor, at least one computer-readable storage media and communication means for communicating via radio frequency signals with said first device detection unit, said second device detection unit and/or said identification detection units. The CMS is devoted to interact with the DDU's and IDU's and to provide monitoring functionalities as will be explained below. During the system installation, a timing reference is set by the CMS for each unit (DDUs, IDUs) ensuring consistent and synchronized operations. The CMS tasks are:
DDUs' and IDUs' operations timing,
position data gathering and management for each mobile unit operating in the warehouse, and
storage of the data and analysis.

The operations conducted by system 100 are as follows:
1. During a first step, the CMS furnishes the timing to the system and sequentially activates the unit
2. During a second step, the timing signal activates only a row at a time. The time slot allocated for each row operation has a duration of a few milliseconds (typically: 1-2 ms).
3. During a third step, the CSM continuously scans in sequence the rows.
4. During a fourth step, the CSM starts activating the DDUs.
5. During a fifth step, the active DDU transmits in the 5.8 GHz ISM band and receives in the 2.4 GHz ISM band. 6. During a sixth step, a spread spectrum signal (10 MHz bandwidth) is transmitted.
7. During a seventh step, each mobile unit (MU) receiving in the 5.8 GHz band and re-transmitting the incoming signal in the 2.4 GHz band.
8. During an eighth step, the active DDU receives the radio frequency signals transmitted by the MUs present in the row (if any).
9. During a ninth step, the DDU transmits to the IDU in the same row the positions of the Mus.
10. The IDU is activated and transmits in the 5.8 GHz band a coded ID query signal.
11. During a eleventh step, each MU present in the row answers to the query with its unique ID.
12. During a twelfth step, the IDU associates at each position the detected ID and sends the data to the CSM.
13. During a thirteenth step, the CMS continuously stores the ID/position data.

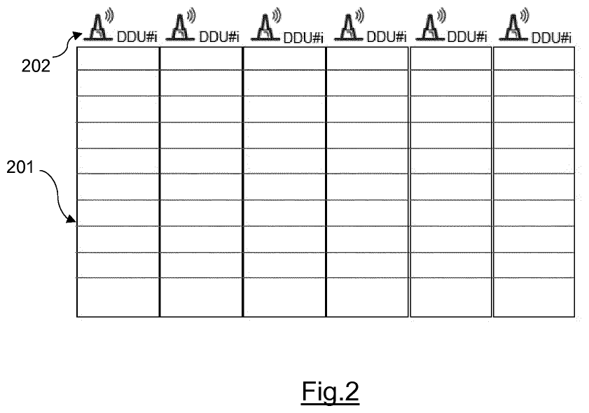

Moreover, as illustrated on FIG. 2, when a plurality of racks 201 are arranged in each row of said warehouse, additional device detection units 202 are fixed with fixing means (adhesive, glue, screws, bolts, etc.) in each one of said rack. With respect to the process described above, each one of said additional DDUs performs the same operations as the DDUs 101 arranged at one end of each row. Accordingly, additional DDUs 202 comprise the same elements than the DDUs 101. Those elements are described below.

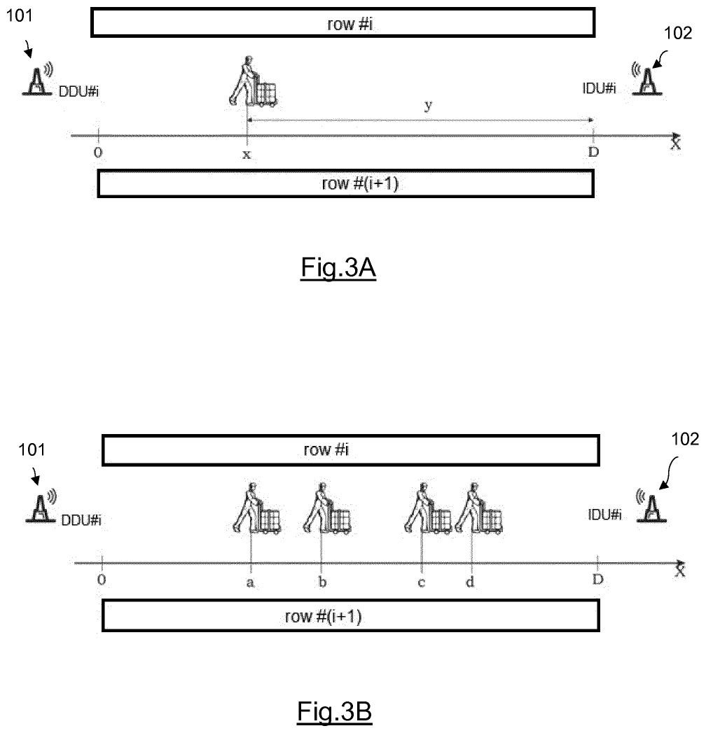

On FIG. 3, a mobile unit according to the invention is arranged on forklift 301 which moves in a corridor formed between two rows of the warehouse, identified on the figure by “row #i” and “row #(i+1)”. Given the geometry in figure, we see that the distance y=D−x.

The time-slot T allocated for the DDU operations is long at least: T=D/c s, with D=length of the corridor between the rows, in meters and c=speed of the light, i.e. 3×10⁸ m/s.

The DDU detects the position, as explained below, and, considering the worst case for the signal coming forth and back from the rightmost part of the corridor, needs a 2×T time slot. In the case of only one MU in the corridor, the IDU action is quite trivial.

The sense of the IDU is clear when we consider an ambiguous scenario with multiple MUs in the corridor, as illustrated by FIG. 3B.

In this scenario, we must recall that, at the end of its time-slot, the DDU transmits to the IDU the number of detected MUs and their positions (a, b, c, d in FIG. 3B).

When the IDU makes the query for identification, a 2T timeslot is equally required.

The received IDs are associated to the position sequence in reverse order, that is, the first ID is associated to the ‘d’ position, the second to ‘c’ and so on. Finally, at the end of the time slot, the IDU transmits to the CMS the ID\position data.

The time needed for the overall series of operation is of the order of 4×T. In the assumption made at the beginning of the document of a corridor length of 250 m, the time needed for ID\position detection is: 4×T=4×(250/3.10⁸)≈3.5 μs.

The DDU, thus, may easily repeat the position process 10-15 times to statistically improve the detection accuracy without increasing the latency.

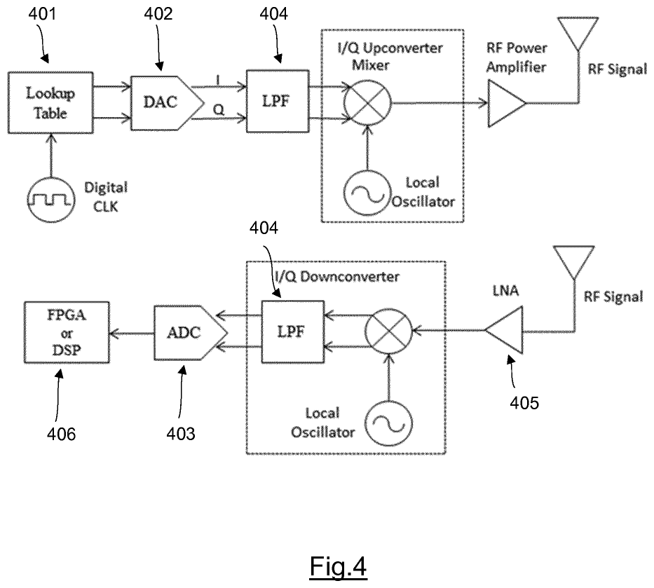

FIG. 4 illustrates the architecture of the DDUs. As shown, each DDU comprises storage means in the form of a look-up table (LUT) 401, a digital-to-analog converter (DAC) 402, an analog-to-digital converter (ADC) 403, two low-pass filters (LPF) 404 and one low-noise amplifier (LNA) 405. It is further provided with RF antennas that are configured to transmit and receive radio frequency signals with frequencies as mentioned above.

The transmitted signal results from a digital generation performed by first storing the transmitter sequence in the LUT and, then, accessing the stored data and converting them back in an analog format. The sequence is in a complex format (in-phase and quadrature components). The analog signal is up-converted in the desired ISM band (5.8 GHz), amplified and transmitted. The receiver mirrors the transmitter architecture with the sole difference that it operates in the 2.4 GHz ISM band. The received signal, converted in a digital format by the analog-to-digital converter (ADC), undergoes a post-processing manipulation performed by a suitable digital signal processor (DSP) 406.

The distance measurements rely on the properties of a particular sequence of the constant-amplitude zero auto-correlation type, encoded using orthogonal frequency-division multiplexing. The encoded sequence samples are stored in the LUT and transmitted. The resulting transmitted signal is extremely robust against the multipath interferences.

The cross-correlation of the received signal, suitably sampled, with the copy of the transmitted signal stored in the LUT allows extracting the MU distance.

Examples of received signals are shown on FIG. 5. The minimum axial resolution and the precision of the distance evaluation depend by the length of the sequence and the number of OFDM sub-carriers employed (that is the bandwidth). Obviously, the higher the required precision is the more complex and expensive the DDU results, mostly for the ADC and DSP requirements. A bandwidth of a few MHz (5-10) is a reasonable trade-off between accuracy (0.5 m) and cost.

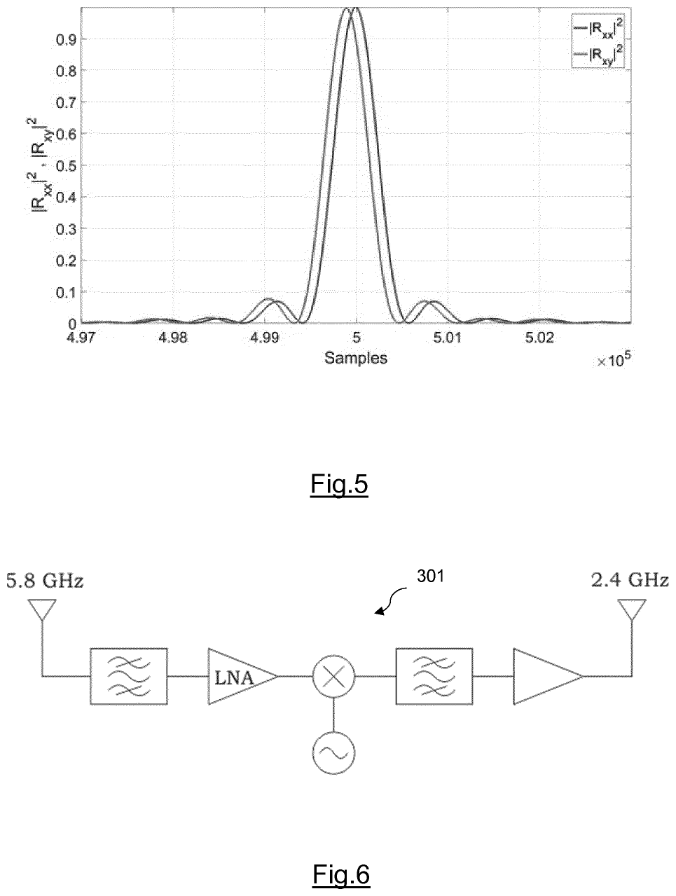

FIG. 6 illustrates the architecture of a mobile unit 301 which location is determined by the system 100. The MU receives the 5.8 GHz signal, down-converts it in the 2.4 GHz and transmits it back to the DDU.

The MU 301 is adapted and configured to receive radio frequency signals which frequencies are comprised between 5,725 GHz and 5,875 GHz and to transmit radio frequency signals which frequencies are comprised between 2.4 GHz and 2.5 GHz and between 433.05 MHz and 434.79 MHz. For the latter, it contains a second ISM transceiver operating in the 433 MHz ISM band, devoted to transmit the unique unit ID upon interrogation of the Identification Detection Unit (IDU).

1. A system for determining the location of at least one mobile unit within a warehouse, said mobile unit being configured to receive radio frequency signals which frequencies are comprised between 5,725 GHz and 5,875 GHz and to transmit radio frequency signals which frequencies are comprised between 2.4 GHz and 2.5 GHz and between 433.05 MHz and 434.79 MHz, characterized in that said system comprises:
at least a first device detection unit and a second device detection unit, both being configured to transmit radio frequency signals which frequencies are comprised between 5,725 GHz and 5,875 GHz and to receive radio frequency signals which frequencies are comprised between 2.4 GHz and 2.5 GHz, and
at least one identification detection unit configured to transmit radio frequency signals which frequencies are comprised between 5,725 GHz and 5,875 GHz and to receive radio frequency signals which frequencies are comprised 433.05 MHz and 434.79 MHz.

2. The system according to claim 1, wherein both of said first device detection unit and said second device detection unit comprise a look-up table in which at least one constant-amplitude zero auto-correlation sequence is stored.

3. The system according to claim 2, wherein both of said first device detection unit and said second device detection unit are configured to allow said sequence to be encoded using orthogonal frequency-division multiplexing to determine an encoded sequence sample.

4. The system according to claim 3, wherein said look-up table includes at least one version of said encoded sequence sample.

5. The system according to claim 1, wherein both of said first device detection unit and said second device detection unit comprise a digital signal processor.

6. The system according to claim 1, wherein both of said first device detection unit and said second device detection unit comprise a low-noise amplifier.

7. The system according to claim 1, wherein both of said first device detection unit and said second device detection unit comprise an analog-to-digital converter and a digital-to-analog converter.

8. The system according to claim 1, wherein both of said first device detection unit and said second device detection unit comprise at least one low-pass filter.

9. The system according to claim 1, wherein both of said first device detection unit and said second device detection unit comprise a digital clock.

10. The system according to claim 1, wherein it further comprises a central management system comprising at least one processor, at least one computer-readable storage media and communication means for communicating via radio frequency signals with said first device detection unit, said second device detection unit and/or said identification detection unit.

11. The system according to claim 1, wherein said second device detection unit comprises fixation means for fixing said second device detection unit in a rack.

12. A warehouse comprising a system according to claim 1.

13. The warehouse according to claim 12, wherein said first device detection unit is arranged on one side of said warehouse, said identification detection unit is arranged on the other side of said warehouse and said second device detection unit is arranged between said first device detection unit and said second device detection unit.
